(19) United States
(12) Patent Application Publication
(10) Pub. No.: US 2014/0326779 A1
(43) Pub. Date: Nov. 6, 2014

(54) Inflatable Purge Dam Apparatus With Diffuser

(71) Applicant: Michael Hacikyan, Naples, FL (US)

(72) Inventor: Michael Hacikyan, Naples, FL (US)

(21) Appl. No.: 13/875,065

(22) Filed: May 1, 2013

(51) Int. Cl. B23K 37/00

(52) U.S. Cl. CPC B23K 37/00
USPC 228/42

(57) ABSTRACT

An inflatable purge dam apparatus includes first and second inflatable purge bladders defining a weld-zone therebetween. A purge gas discharge port is adapted to deliver a purge gas into the weld zone. A purge gas diffuser is in fluid communication with the gas discharge port. The purge gas diffuser is operable to diffuse the purge gas as it enters the weld zone.

### BACKGROUND

1. Field

The present disclosure relates generally to inert gas welding. More particularly, the invention is directed to inflatable purge dams for retaining purge gas around a weld zone.

2. Description of the Prior Art

By way of background, inert gas welding is a species of arc welding in which the molten weld pool is shielded from atmospheric contamination and oxidation by bathing it with an inert gas, such as Argon, or a mixture of Helium and Argon. Popular examples of inert gas welding include TIG (Tungsten Inert Gas) welding and MIG (Metal Inert Gas) welding.

When welding together pipes and other enclosed structures using inert gas welding, it is important to purge the interior of the pipe or structure in the vicinity of the weld zone to prevent corrosion and the formation of oxides on the interior side of the weld pool. Purge dams are conventionally used for this purpose. For example, when butt-welding the ends of two pipe sections to form a consolidated pipe run, two purge dam structures are placed in the pipes, one in each pipe on either side of the weld zone. A purge gas can then be introduced into the area between the dams.

One well-known purging device used for pipe welding applications is the inflatable purge dam. As shown in FIG. 1, an inflatable purge dam typically include a pair of inflatable purge dam bladders 2 and 4 mounted on a purge gas delivery tube 6. The inflatable bladders usually comprise an inner bladder made from a resilient gas-impermeable material (such as latex rubber), and an outer protective cover made from fabric or other material (such as nylon) to protect the inner bladder from welding heat and caustic chemicals. The purge gas delivery tube is apertured inside the inflatable bladders so that the bladders will inflate when a purge gas “PG” is introduced. The purge gas delivery tube includes a pressure-sensitive gas discharge valve assembly 8. The gas discharge valve assembly 8 has a gas delivery outlet 10 and is located in the weld zone 12 that exists between the bladders. The discharge valve is designed to open when the purge gas reaches a predetermined pressure that is sufficient to inflate the bladders and ensure that the bladders form effective weld zone seals with the inside walls of the pipes to be welded. Once the weld zone seals have been formed, the discharge valve will open, thereby releasing purge gas from the gas delivery outlet into the weld zone. An air vent tube 14 typically extends through an outside portion of one of the bladders. The vent tube vents air from the weld zone as it is displaced by the purge gas, and may be connected to oxygen monitoring equipment for monitoring the oxygen content within the weld zone.

It is to improvements in the design and operation of inflatable purge dams that the present disclosure is directed.

### SUMMARY

Embodiments of an improved inflatable purge dam apparatus for pipe welding are disclosed. In one aspect, the inflatable purge dam apparatus includes first and second inflatable purge bladders defining a weld-zone therebetween. A purge gas discharge port is adapted to deliver a purge gas into the weld zone. A purge gas diffuser is in fluid communication with the gas discharge port. The purge gas diffuser is operable to diffuse the purge gas as it enters the weld zone.

In another aspect, the inflatable purge dam apparatus includes first and second inflatable purge bladders joined by a bridge conduit. The first purge bladder has a first interior gas-receiving chamber and defines a first port on one side thereof and a second port on another side thereof. The second purge bladder has a second interior gas-receiving chamber and defines a third port on one side thereof. The bridge conduit extends between the second port on the first purge bladder and the third port on the second purge bladder, and provides fluid communication between the first gas-receiving chamber and the second gas-receiving chamber. The bridge conduit mounts a pressure-sensitive gas discharge valve assembly that is operable to release a purge gas into a weld zone formed between the first purge bladder and the second purge bladder when the purge bladders have been inflated with the purge gas to a predetermined sealing pressure that is effective to seal the weld zone. A purge gas diffuser is in fluid communication with the gas discharge valve assembly and is operable to diffuse the purge gas as it enters the weld zone.

### BRIEF DESCRIPTION OF THE DRAWINGS

The foregoing and other features and advantages will be apparent from the following more particular description of example embodiments, as illustrated in the accompanying Drawings, in which:

FIG. 1 is a side elevation view showing a prior art inflatable purge dam apparatus;

FIG. 2A is a side elevation view showing an example embodiment of an inflatable purge dam apparatus in a deflated condition;

FIG. 2B is a side elevation view showing the inflatable purge dam apparatus of FIG. 2A in an inflated condition;

FIG. 3 is a side elevation view showing a portion of the inflatable purge dam apparatus of FIGS. 2A and 2B, and including an inset showing example purge gas discharge components;

FIG. 4 is an enlargement of the inset shown in FIG. 3 illustrating an example diffuser;

FIG. 5 is a plan view showing a diffuser screen that may be used in the diffuser of FIG. 4;

FIG. 6 is a plan view showing a modified diffuser screen that may be used in the diffuser of FIG. 4; and

FIG. 7 is a plan view showing another modified diffuser screen that may be used in the diffuser of FIG. 4.

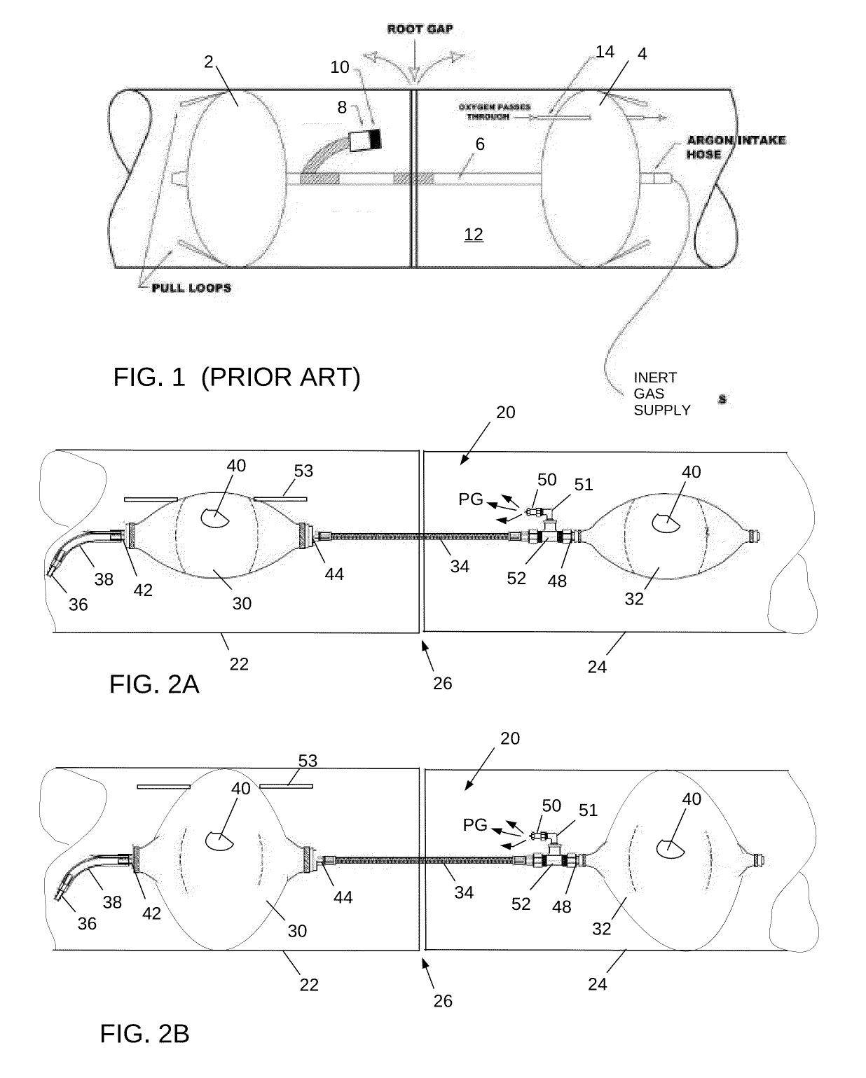

### DETAILED DESCRIPTION OF EXAMPLE EMBODIMENTS

Turning now to the drawing figures, which are not necessarily to scale, like reference numbers are used to represent like elements in all of the several views. In FIGS. 2A and 2B, an example inflatable purge dam apparatus 20 is disposed inside a pair of pipes 22 and 24 that are to be butt-welded together at a welding root gap 26. The purge dam apparatus 20 has first and second inflatable purge bladders 30 and 32 that are joined together by an intermediate bridge conduit 34. FIG. 2A shows the purge dam apparatus 20 in a deflated condition following installation in the pipes 22/24 but prior to inflation of the purge bladders 30/32. FIG. 2B shows the purge dam apparatus 20 after the purge bladders 30/32 have been inflated with a purge gas PG. The enclosed space between the purge bladders 30/32 represents a weld zone 28 that has been purged of air by the purge gas following the introduction thereof through an inflation purge gas entry port 36 situated at the end of a purge gas inlet conduit 38.

The first purge bladder 30 has a first interior gas-receiving chamber 40 and defines a first port 42 on one side thereof and a second port 44 the opposite side thereof The first port 42 and the second port 44 may be aligned proximate to a central longitudinal axis of the first purge bladder 30. The second purge bladder 32 has a second interior gas-receiving chamber 46 and defines a third port 48 on one side thereof The third port 48 is aligned proximate to a central longitudinal axis of the second purge bladder 32.

The bridge conduit 34 extends between the second port 44 on the first purge bladder 30 and the third port 48 on the second purge bladder 32. The bridge conduit 34 provides fluid communication between the first gas-receiving chamber 40 of the first purge bladder 30 and the second gas-receiving chamber 46 of the second purge bladder 32. Near its right-hand end in FIGS. 2A and 2B, the bridge conduit 34 has a pressure-sensitive gas discharge valve assembly 50. The gas discharge valve assembly 50 is mounted at the end of an elbow 51 that is threaded into a three-way T-fitting 52 that is mounted to, and forms a part of, the bridge conduit 34. The gas discharge valve assembly 50 has an internal valve (not shown) that is operable to release purge gas into the weld zone 28 when the first and second purge bladders 30/32 have been inflated (by the purge gas) to a predetermined sealing pressure that is effective to seal the weld zone. In particular, the gas discharge valve assembly 50 may be set to open at the minimum pressure that will allow the first and second purge bladders 30/32 to fully inflate and form an adequate seal against the inside walls of the pipes 22 and 24. This will represent the pipe inside diameter for which the purge dam apparatus 20 is designed to be used.

An air vent tube 53 extends through the outer peripheral portion of the first purge bladder 30 in order to provide an air pathway for venting air from the weld zone 28 as the weld zone fills with the purge gas PG. An alternative air venting arrangement, such as the one disclosed in Applicant's copending U.S. patent Ser. No. 12/646,393, could also be used. As shown in FIGS. 2A and 2B, the bridge conduit 34 carries a purge gas PG introduced at the inflation purge gas entry port 36 to inflate the first and second purge bladders 30/32, and to thereafter fill the weld zone 28 once the valve within the gas discharge valve assembly 50 opens.

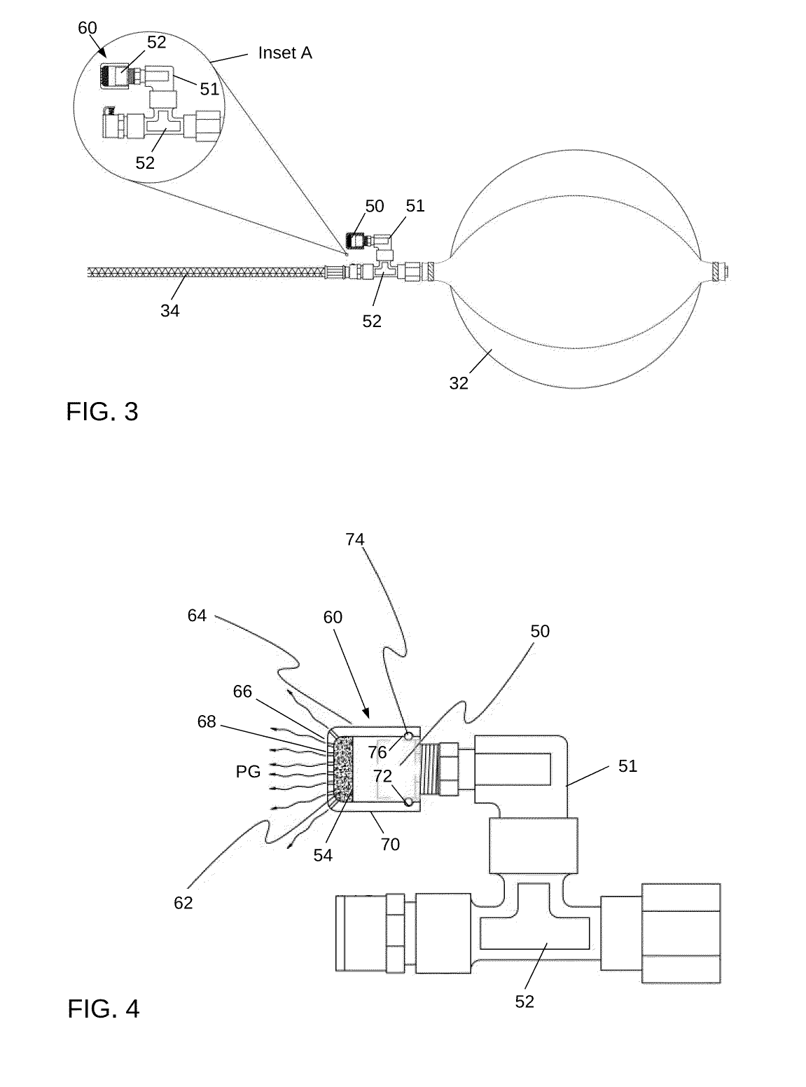

Turning now to FIG. 3, an enlarged view of the gas discharge valve assembly 50, the elbow 51 and the T-fitting 52 is shown within inset A, and a further enlarged view of the structure shown in inset A is shown in FIG. 4. It will be seen in FIG. 3 that the gas discharge valve assembly 50 includes a purge gas discharge port 54 that is adapted to deliver a purge gas PG into the weld zone.

In contrast to prior art inflatable purging devices, the purge dam apparatus 20 is provided with a purge gas diffuser 60 that is in fluid communication with the gas discharge port 54, and is operable to diffuse the purge gas PG as it enters the weld zone. This improves purge dam operation by preventing the purge gas PG from forcefully entering the weld zone 28 in a high velocity stream that produces pressure imbalances that can compromise the purging effort. Instead, the high velocity flow of the purge gas PG is disrupted, causing it to enter the weld zone 28 in a diffused state and disperse at relatively low velocity in multiple directions.

As best seen in FIG. 4, the purge gas diffuser 60 includes a diffusion medium 62. The diffusion medium 62 may be constructed using any suitable material that is sufficiently disruptive to the purge gas PG to cause it to slow it down and disperse into the weld zone, yet not so restrictive as to unduly minimize the purge gas pressure. In an example embodiment, the diffusion medium 62 may be implemented as a mesh of suitable porosity. The mesh may comprise a bundle of filament strands, a wire cloth, a screen, or any other suitable mesh-like structure. The mesh may be made from any suitable material. By way of example only, the mesh may be selected from the group consisting of metals, polymers, fabrics and paper materials. Other mesh materials could also be used. Other embodiments of the diffusion medium 62 could use different types of mesh constructions, as well as a variety of non-mesh constructions, such as baffle structures.

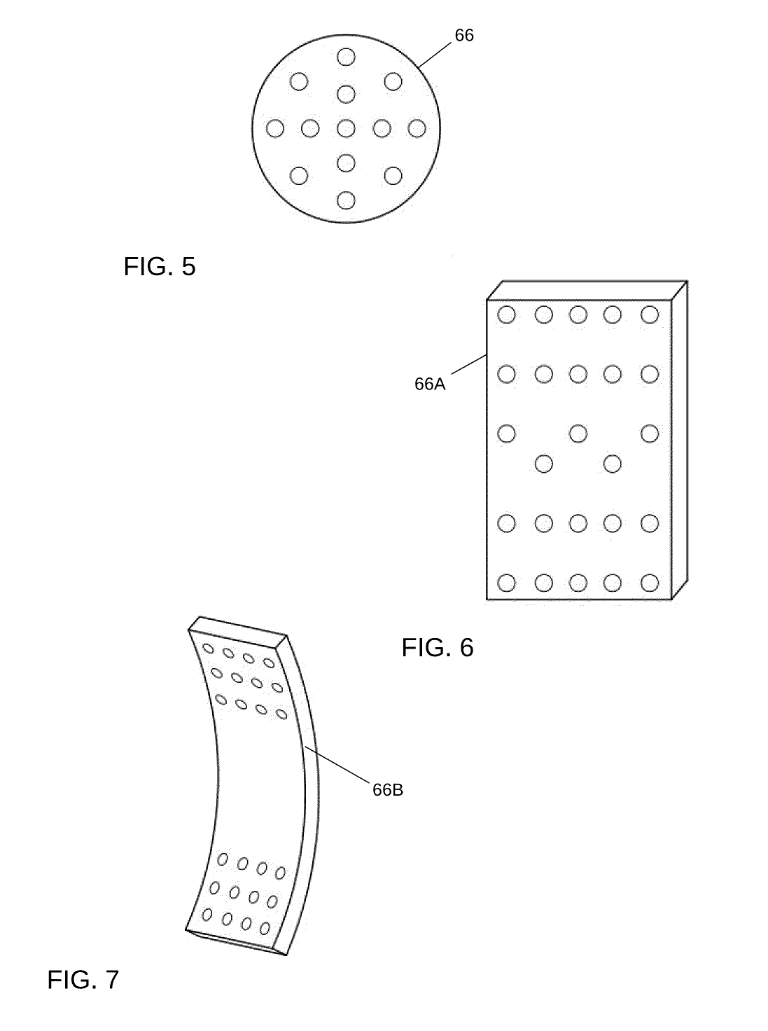

The diffusion medium 62 may be disposed within a diffuser housing 64. The diffuser housing 64 may include a diffuser grating 66 that may be used in some embodiments of the diffusion medium 62 to help retain it in position against the gas discharge port 54. The diffuser grating 66 has plural openings 68 that allow the purge gas PG to escape from the diffuser 60, and which also provide further purge gas diffusion. The diffuser grating 66 may be constructed with various shapes. For example, if the diffuser housing 64 is cylindrical (as shown in FIG. 4), the diffuser grating 66 may be generally circular (as shown in FIG. 5). If the diffuser housing 64 is polygonal (not shown), the diffuser grating 66 may be generally polygonal (as shown by reference number 66A in FIG. 6). Although FIG. 4 shows the face of the diffuser grating 66 as being generally planar, the face could also be generally outwardly (or inwardly) curved (as shown by reference number 66B in FIG. 7). Other configurations could also be used.

Returning now to FIG. 4, the diffuser housing 64 includes a main housing body 70 that can be mounted to the gas discharge valve assembly 50 (or to adjacent structure). The housing body 70 is shown as being cylindrical in shape, but could also have polygonal or other shapes, as previously mentioned. The inside of the diffuser housing body 70 may be formed with a seal retainer 72 for seating the outside diameter of an O-ring resilient seal 74. The outside diameter of the resilient seal 74 seats in the seal retainer 72, and engages the outside of the gas discharge valve assembly 50 or other structure on which the diffuser housing body 70 is mounted. In the construction of FIG. 4, the outside of the gas discharge valve assembly 50 is cylindrical to match the cylindrical shape of the diffuser housing body 70, and includes a seal retainer 76 that seats the inside diameter of the resilient seal 74.

Accordingly, an inflatable purge dam apparatus has been disclosed. Although various embodiments have been shown and described, it should be apparent that many variations and alternative embodiments could be implemented in accordance with the invention. It is understood, therefore, that the invention is not to be in any way limited except in accordance with the spirit of the appended claims and their equivalents.

What is claimed is:

1. In an inflatable purge dam apparatus for pipe welding:
first and second inflatable purge bladders defining a weld-zone therebetween;
a purge gas discharge port adapted to deliver a purge gas into said weld zone; and
a purge gas diffuser in fluid communication with said gas discharge port, and operable to diffuse said purge gas as it enters said weld zone.

2. The purge dam apparatus of claim 1, wherein said purge gas diffuser comprises a diffusion medium that disperses said purge gas as it flows into said weld zone.

3. The purge dam apparatus of claim 1, wherein said diffusion medium comprises a mesh.

4. The purge dam apparatus of claim 1, wherein said mesh comprises a bundle of filament strands, a wire cloth, or a screen, said mesh comprising a material selected from the group consisting of metals, polymers, fabrics and paper materials.

5. The purge dam apparatus of claim 2, wherein said diffusion medium is disposed within a diffuser housing that comprises a diffuser grating having plural openings for further diffusing said purge gas.

6. The purge dam apparatus of claim 5, wherein said diffuser grating is generally circular.

7. The purge dam apparatus of claim 5, wherein said diffuser grating is generally polygonal.

8. The purge dam apparatus of claim 5, wherein said diffuser grating comprises a face that is generally curved.

9. An inflatable purge dam apparatus for pipe welding, comprising:
a first inflatable purge bladder having a first interior gas-receiving chamber and defining a first port on one side thereof and a second port on another side thereof;
a second inflatable purge bladder having a second interior gas-receiving chamber and defining a third port on one side thereof;
a bridge conduit extending between said second port on said first purge bladder and said third port on said second purge bladder, said bridge conduit providing fluid communication between said first gas-receiving chamber and said second gas-receiving chamber;
a pressure-sensitive gas discharge valve assembly operable to release a purge gas into a weld zone formed between said first purge bladder and said second purge bladder when said first purge bladder and said second purge bladder have been inflated with said purge gas to a predetermined sealing pressure that is effective to seal said weld zone; and
a purge gas diffuser in fluid communication with said gas discharge valve assembly, and is operable to diffuse said purge gas as it enters said weld zone.

10. The purge dam apparatus of claim 9, wherein said purge gas diffuser comprises a diffusion medium that disperses said purge gas as it flows into said weld zone.

11. The purge dam apparatus of claim 10, wherein said diffusion medium comprises a mesh.

12. The purge dam apparatus of claim 11, wherein said mesh comprises a bundle of filament strands, a wire cloth, or a screen, said mesh comprising a material selected from the group consisting of metals, polymers, fabrics and paper materials.

13. The purge dam apparatus of claim 10, wherein said diffusion medium is disposed within a diffuser housing that comprises a diffuser grating having plural openings for further diffusing said purge gas.

14. The purge dam apparatus of claim 13, wherein said diffuser grating is generally circular.

15. The purge dam apparatus of claim 13, wherein said diffuser grating is generally polygonal.

16. The purge dam apparatus of claim 13, wherein said diffuser grating comprises a face that is generally curved.

17. The purge dam apparatus of claim 10, wherein said diffuser housing comprises a housing body.

18. The purge dam apparatus of claim 17, wherein said diffuser housing body comprises a seal retainer for seating a resilient seal.

19. The purge dam apparatus of claim 18, further including a resilient seal seated in said seal retainer and engaging a structure of said purge dam apparatus on which said diffuser housing body is mounted.

20. The purge dam apparatus of claim 19, wherein said diffuser housing body is mounted to said gas discharge valve assembly.

21. An inflatable purge dam apparatus for use pipe welding, comprising:
a first inflatable purge bladder having a first interior gas-receiving chamber and defining a first port on one side thereof and a second port on another side thereof;
a second inflatable purge bladder having a second interior gas-receiving chamber and defining a third port on one side thereof;
a bridge conduit extending between said second port on said first purge bladder and said third port on said second purge bladder, said bridge conduit providing fluid communication between said first gas-receiving chamber and said second gas-receiving chamber;
a pressure-sensitive gas discharge valve assembly operable to release a purge gas into a weld zone formed between said first purge bladder and said second purge bladder when said first purge bladder and said second purge bladder have been inflated with said purge gas to a predetermined sealing pressure that is effective to seal said weld zone;
a purge gas diffuser in fluid communication with said gas discharge valve assembly, and is operable to diffuse said purge gas as it enters said weld zone;
said purge gas diffuser comprising a diffusion medium that disperses said purge gas as it flows into said weld zone;
said diffusion membrane comprising a mesh;
said mesh comprising a bundle of filament strands, a wire cloth, or a screen, said mesh comprising a material selected from the group consisting of metals, polymers, fabrics and paper materials;
said diffusion medium being disposed within a diffuser housing comprising a diffuser grating having plural openings for diffusing said purge gas;
said diffuser grating being generally circular or generally polygonal, and comprising a face that is either planar or generally curved;
said diffuser housing comprising a housing body;
said diffuser housing body comprising a seal retainer for seating a resilient seal;
a resilient seal seated in said seal retainer and engaging a structure of said purge dam apparatus on which said diffuser housing body is mounted; and
said diffuser housing body being mounted to said gas discharge valve assembly.
